(19) United States
(12) Patent Application Publication
(10) Pub. No.: US 2017/0337527 A1
(43) Pub. Date: Nov. 23, 2017

(54) GRAPHICAL USER INTERFACE SERVER AND METHODS THEREIN

(71) Applicant: Storygami Ltd, London (GB)

(72) Inventor: Guy Gunaratne, London (GB)

(21) Appl. No.: 15/157,805

(22) Filed: May 18, 2016

(51) Int. Cl. G06Q 20/10; G06Q 30/06; G06F 3/0484

(52) U.S. Cl. CPC G06Q 20/10; G06F 3/04842; G06Q 30/0643

(57) ABSTRACT

The disclosure proposes a method and electronic device for generating a graphical user interface. The method comprises generating a graphical user interface comprising a first and second area, displaying the graphical user interface, detecting a user input, retrieving payment information, generating a third area, displaying retrieved payment information, receiving user input and performing electronic payment. The electronic device is configured to perform any of the aspects of the method.

### TECHNICAL FIELD

The disclosure pertains to the fields of graphical user interfaces and electronic payments. More particularly, the disclosure relates to a method and electronic device configured for generating a graphical user interface for video and electronic payments.

### BACKGROUND

Graphical user interfaces for playing video have become more frequently used on all kinds of electronic devices from portable electronic devices such as smart phones and tablets, laptops to computers, TVs, home theatres, etc. Traditionally video players are used to present content of a video file or a streamed video. Internet based video services exist. There are also services designed for both web browsers and mobile applications. Some examples of applications with user generated videos are Youtube, Instagram and Tumblr and some examples of on demand video are Netflix, HBO and Viaplay.

Today users can get commercial notifications while watching a video. This can be in form of e.g. link to a web page. The link typically goes to a web page with a particular web shop and the viewer of the video that selects to follow the link will open a web browser in another window. A user can there select products to buy and perform an electronic payment based on different methods offered by the web shop.

Typically, a user that selects to follow a link to a web shop while viewing a video will lose the attention of the video and leave the video viewing or leaving the application that is playing the video. It can be annoying for the user to lose attention of the video and then try to come back to continue viewing. From a business perspective there is also a need for the possibility to offer a quick and easy way of offering products and services that are related to certain content of a video, so that they can very easily get purchased while viewing the video.

### SUMMARY

An object of the present disclosure is to provide a method and a device which seek to mitigate, alleviate, or eliminate one or more of the above-identified deficiencies in the art and disadvantages singly or in any combination.

The disclosure proposes a method, at an electronic device comprising; generating a graphical user interface comprising a first area for displaying a video and a second area for providing user interaction on or next to the first area. The method further comprises displaying the graphical user interface and detecting, while displaying a video, a user input in the second area. This is followed by retrieving, in response to the detecting, from at least one server, payment information associated with the second area and generating, in the graphical user interface, a third area configured for receiving user input for electronic payment, wherein the third area is at least partly overlapping the first area. The method further comprises displaying, in the third area, the retrieved payment information and receiving user input associated with the electronic payment being provided in the third area. Finally the method comprises performing the electronic payment based on the retrieved information and user input received in the third area via a payment server. Hence, a graphical user interface is provided that makes it easy for a user to view a video and perform an electronic payment without leaving the video player or interface providing the playback of the video.

According to some aspects of the disclosure, the method comprises interrupting the displaying of the video in response to detecting a user input in the second area. Hence, the video is paused while the user is performing electronic payment.

According to some aspects of the disclosure, the method comprises resuming the displaying of the video in response to completing the electronic payment. This means that the user can continue to view the paused video without missing any part of the video while completing the electronic payment.

According to some aspects of the disclosure, the payment information comprises price information data stored in at least one server. The price can be either a product price from e.g. a product content server or a price for a donation.

According to some aspects of the disclosure, the third area that is configured for receiving user input for the electronic payment is generated using an application programming interface defining the graphical user interface of the third area. Hence, the data used for generating the graphical user interface is controlled and can be managed to create a well-functioning graphical user interface with a positive user experience.

According to some aspects of the disclosure, the second area is generated on the first area at a specific position providing user interaction during a specific time period while displaying the video. This allows an intuitive way of e.g. providing an advertisement that is related to an object that is visualized in a scene of the video and hence easy accessible for the user that is viewing the video.

According to some aspects of the disclosure, the second area is generated below the first area at a specific position providing user interaction while displaying the video. This makes it possible to always enable electronic payment for the user at any time while watching the video.

According to some aspects of the disclosure, the second area is generated below the first area at a specific position providing user interaction when the video is paused. This makes it possible to enable electronic payment for the user at a time chosen by the user.

According to some aspects of the disclosure, the method is performed in a server adapted to generate a graphical user interface for a web browser or an application displaying the graphical user interface on a display. Hence, the server will process and enable the graphical user interface to be presented on different types of electronic devices.

According to some aspects of the disclosure, the method is performed in a server adapted to generate a graphical user interface and provided via a web server to a web browser or an application displaying the graphical user interface on a display. Hence, the graphical user interface is provided via a web server.

According to some aspects, the disclosure proposes an electronic device configured for generating a graphical user interface. The electronic device comprises a memory and a communication interface for providing communication with at least one server. The electronic device further comprises a processing circuitry that is configured to cause the electronic device to generate a graphical user interface comprising a first area for displaying a video and a second area for providing user interaction on or next to the first area. The processing circuitry is further configured to cause the electronic device to display the graphical user interface and to detect, while displaying a video, a user input in the second area. The processing circuitry is further configured to cause the electronic device to retrieve, in response to the detecting, from at least one server, payment information associated with the second area, to generate in the graphical user interface, a third area configured for receiving user input for electronic payment, wherein the third area is at least partly overlapping the first area, and to display, in the third area, the retrieved payment information. The processing circuitry is further configured to cause the electronic device to receive user input associated with the electronic payment being provided in the third area and to perform the electronic payment based on the retrieved information and user input received in the third area via a payment server. The external electronic device is further configured to perform any of the aspects of the methods described above.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses video streaming and payment in accordance with prior art.

FIG. 2 shows an exemplary system suitable for implementing features described herein.

FIG. 3 is a flowchart illustrating method steps performed in an electronic device according to aspects described herein.

FIG. 4a illustrates a graphical user interface comprising an area for displaying a video and an area for receiving using interaction for initiating electronic payment.

FIGS. 4b to 4d show different alternative implementations of the area for receiving user input for performing the electronic payment in FIG. 4a.

FIGS. 5a, 5b and 6 illustrate different graphical user interfaces comprising an area for displaying a video and an area for receiving using interaction for initiating payment.

FIGS. 7a and 7b illustrate a graphical user interface comprising an area for displaying a video, an area for receiving using interaction for initiating payment and an area for receiving user input for performing the electronic payment.

FIG. 8 shows an exemplary electronic device suitable for implementing features described herein.

### DETAILED DESCRIPTION

Aspects of the present disclosure will be described more fully hereinafter with reference to the accompanying drawings. The method and device disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

In video players today, the main purpose is to enable video viewing. In a video the user viewing the video may see something that is interesting and that the user wants to invest money in. This could for example be a product, but could also be e.g. a donation to be made, or to start a subscription to a service etc. Videos can contain information such as a link to a web page. When a user selects to follow the link the user however leaves the viewing of the video and typically another web browser window is opened that is e.g. a web shop in an ordinary web page. In a smartphone a video may be played in a certain application that is run on the smartphone. When selecting a link to/for another application, e.g. a web browser may instead be opened. The user then loses the attention to the video and the attention of the user is drawn to something else and there may be difficulties for the user to go back to viewing or the user may even not go back.

The inventor has identified that there is a need for a solution where the user can view a video and stay in a video viewing session while performing an electronic payment e.g. buying a product, making a donation or starting a subscription etc. and then being able to continue to view the video. This is done without leaving the video viewing session. The inventor has also identified that a common user interface created via a certain application programming interface will make it easier for the user to use for making the electronic payment while viewing a video, rather than to have different user interfaces generated by each web shop themselves, that will have different appearances each time the user wants to make an electronic payment.

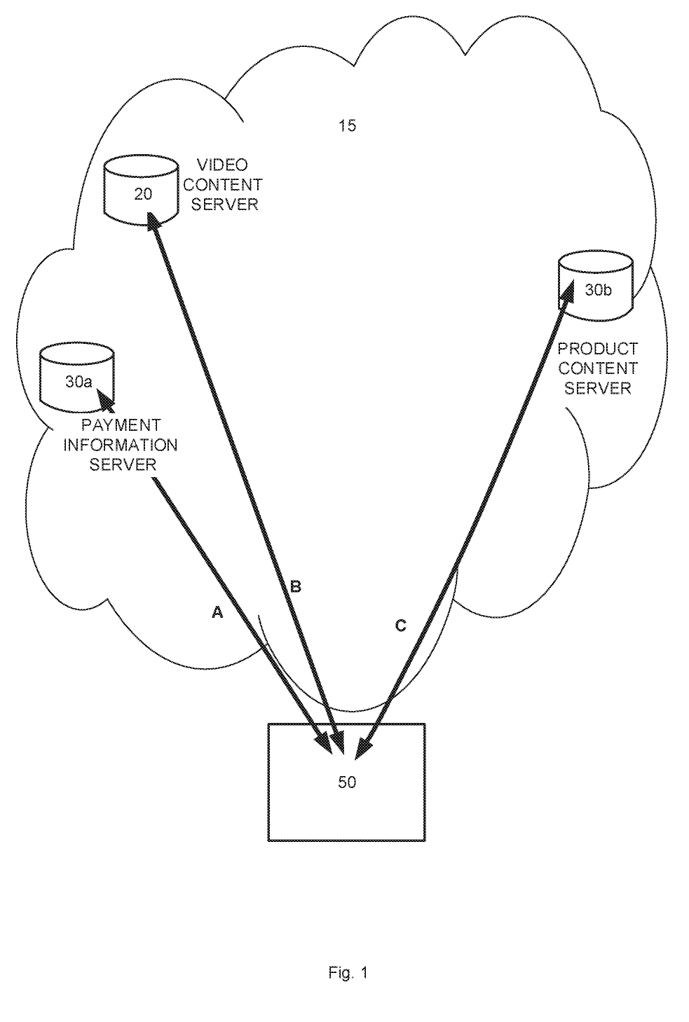

FIG. 1 discloses an example of how video streaming to a user and electronic payment is carried out in accordance with the prior art. In the prior art, a user can view a video that is streamed from a video content server 20, e.g. a YouTube video. The video information B is streamed over the Internet 15 directly to the user, e.g. to a smartphone, and displayed on a display 50 of the smartphone. When viewing the video, a link can appear e.g. associated with an item that can be bought. The user can select to follow the link presented in the video that can be directed to e.g. a web shop connected to a product content server 30b. Product information C regarding a specific product can be retrieved from the content server 30b and presented to the user. Typically this is done in a separate web browser window that is opened and presented on the display 50. If the user wants to purchase the product presented by the web shop, the electronic payment to be performed is then completed via an electronic payment service provider, such as Paypal. The electronic payment service provider typically utilizes a payment information server 30a supporting the web shop. The payment information server 30a can have a direct connection with the user's smartphone for presentation payment information A on the display 50. Hence, the user of the smartphone will have to leave the viewing of the video to complete the electronic payment in a different graphical user interface controlled and defined by the web shop and even complete the electronic payment in yet another graphical user interface.

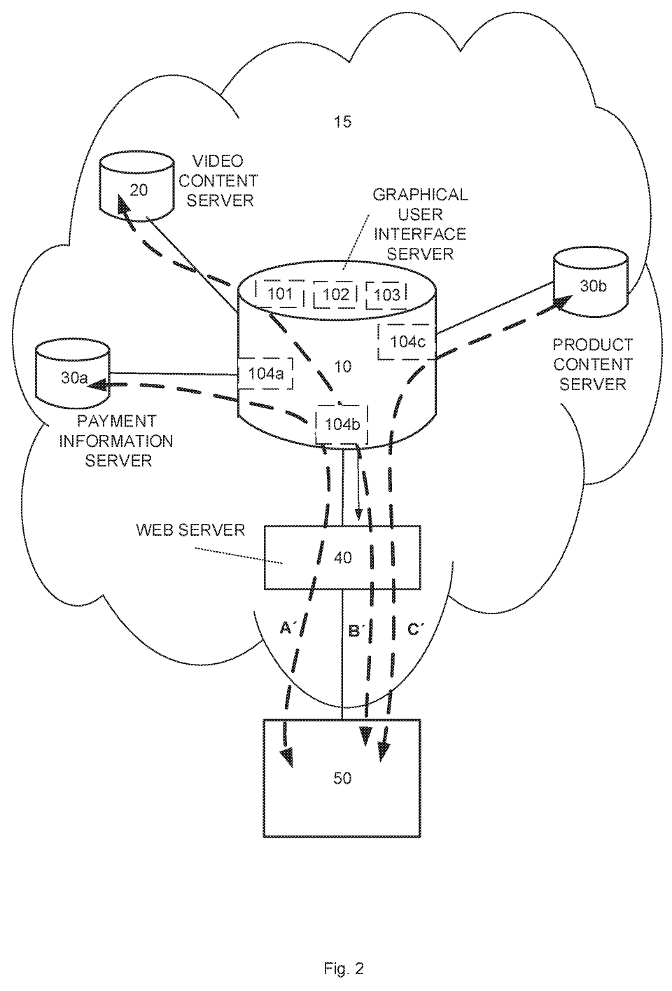

FIG. 2 illustrates an exemplary system suitable for implementing the proposed technique. The proposed technique is, in contrast to the prior art, making use of an electronic device 10 in order to generate a graphical user interface for electronic payment while viewing a video. The system comprises an electronic device 10. The electronic device 10 comprises a memory 101, a communication interface 102, a processing circuitry 103 and an application programming interface 104a, 104b, 104c. The electronic device is connected to the servers 30a, 30b and a video content server 20. The electronic device 10 is further connected to a display 50 via a web server 40. The electronic device 10 may be a server, in particular a graphical user interface server.

The server 30a is a payment information server. This server is an electronic device comprising communication module, processing means, and a memory. The memory can store e.g. bank account information, credit card information, personal information in order to complete an electronic payment. The information can be sent to the electronic device 10 over the Internet 15 using the communication module.

The server 30b is a product content server. This server is an electronic device comprising a communication module, processing means, and a memory. The memory can store e.g. product information, price information, product availability information etc. The information can be sent to the electronic device 10 over the Internet 15 using the communication module.

The server 20 is a video content server. This server is an electronic device comprising a communication module, processing means, and a memory. The memory can e.g. store video files such as movies, short videos or any audio visual data. The video files can be sent or streamed to the electronic device 10 over the Internet 15 using the communication module.

The server 40 is a web server. This server is an electronic device comprising a communication module, processing means, and a memory. The web server provides the user with web pages to be displayed via a web browser on e.g. a personal computer or a smartphone over the Internet 15 using the communication module.

The display 50 may be an ordinary display on a personal computer or a television. The display can also be a touch display on a smartphone or tablet that is also adapted to receive input from a user via the touch display.

FIG. 2 also exemplifies how the different parts of the system are interconnected via the Internet 15. In the example of FIG. 2 a graphical user interface server 10 is connected to a payment information server 30a, a product content server 30b, a video content server 20 and a display 50 via a web server 40 via the Internet 15.

According to some aspects of the disclosure, a graphical user interface server 10 comprises an application programming interface configured for controlling information to be presented to the user. More particularly the application programming interface enables external devices such as a web server to access the functionality of the graphical user interface server and provide a user with a graphical user interface according to the disclosure. As illustrated in FIG. 2, the generated graphical user interface can be presented on the display 50 of the user's device e.g. a smartphone. According to some aspects of the disclosure the method and device is using at least one application programming interface 104a, 104b, 104c in the connection with a server 20, 30a, 30b, 40 to control the generation of the graphical user interface. According to some aspects of the disclosure, the server 20, 30a, 30b, 40 comprises an application programming interface to enable the graphical user interface server 10 to access functionality of the server 20, 30a, 30b, 40.

In the example in FIG. 2, a payment information server 30a and a product content server 30b are connected to a graphical user interface server 10. In the example the purpose of using application programming interfaces is to provide content to the user in form of a graphical user interface that is comfortable and easy to use for a user viewing a video that wants to perform an electronic payment while viewing a video without leaving the video player or interface providing the playback of the video.

For example, as illustrated in FIG. 2, the information B″ from the video content server 20 to the display 50 goes via the graphical user interface server 10 providing a graphical user interface with e.g. additional information for user interaction to be presented to the user on a display 50. Similarly, at least some information A′, C′ to and from e.g. a payment server 30a and a product server 30b also goes via the graphical user interface server 10 in order generate a graphical user interface according to the present disclosure that will now be described in more detail.

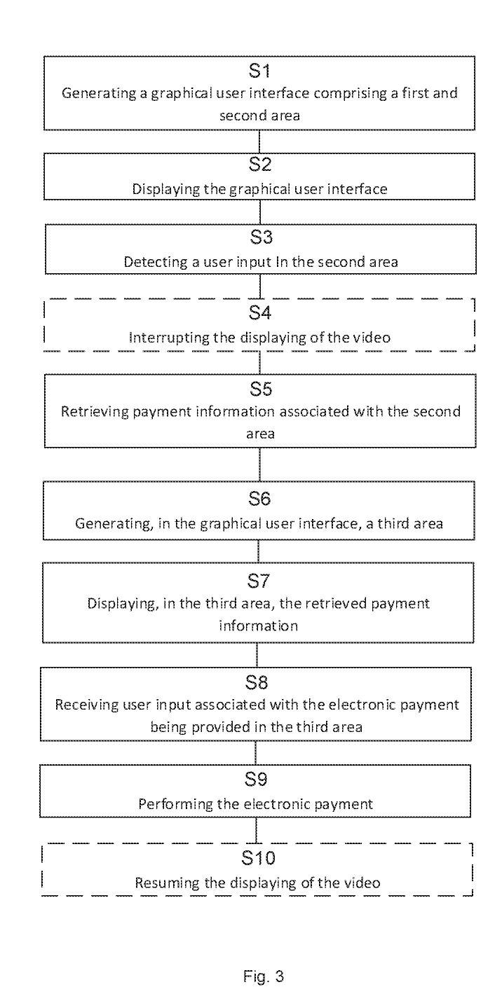

The proposed method performed in an electronic device 10, will now be described with reference to the blocks S1 to S10 of the flow chart in FIG. 3.

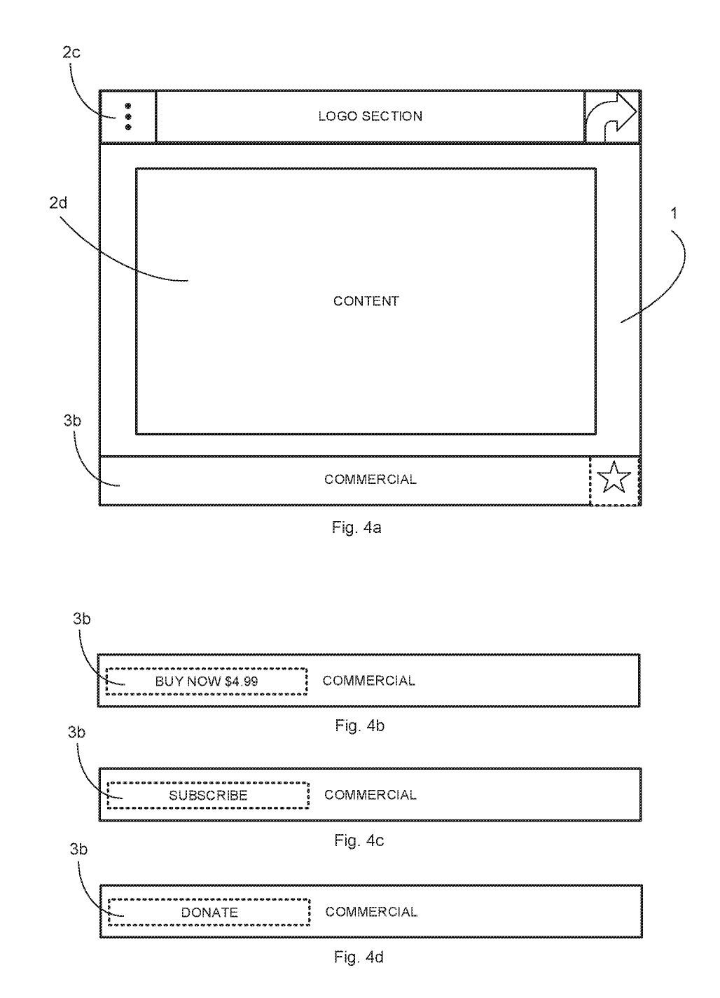

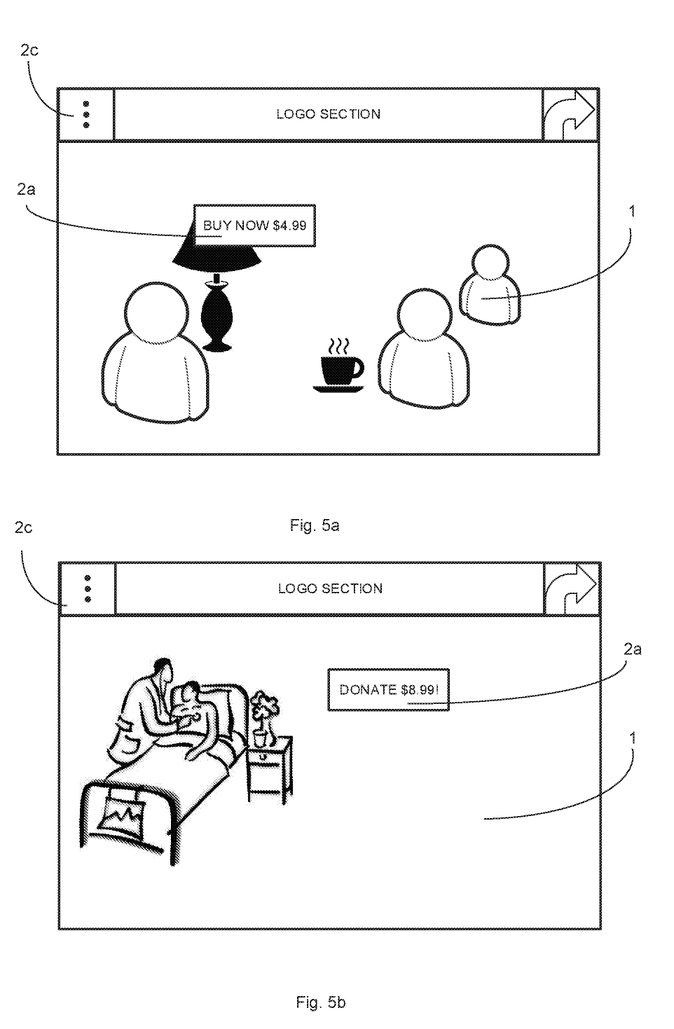

The method comprises generating S1 a graphical user interface comprising a first area 1 for displaying a video and a second area 2a, 2c, 2d for providing user interaction on or next to the first area 1. According to some aspects of the disclosure the method comprises generating S1 a graphical user interface comprising a first area 1 displaying a video and a second area 2a, 2c, 2d providing user interaction on or next to the first area 1. According to some aspects of the disclosure, the graphical user interface is generated by the processing circuitry 103 of the electronic device 10. According to some aspects of the disclosure the graphical user interface is generated according to instructions by a user given in a software program that is used for generating the graphical user interface. The software program may be running on a computer that is connected to the electronic device 10. The electronic device can be a graphical user interface server 10. The first area 1 for displaying a video may e.g. be a window viewing a streamed video such as a Youtube video. The second area for providing user interaction may e.g. be an object that can be selected by the user. For example it can be an object that the user can select by touching the object on a touch display or selecting by “clicking” on the object with a mouse connected to a personal computer. As illustrated in FIG. 4a, the second area 2d for user interaction may display “CONTENT” such as an image, a text box containing e.g. product information or e.g. an article, a map, an e-mail or e.g. a capture form. The second area 2d can also be a video. As illustrated in FIG. 3, the method further comprises displaying S2 the graphical user interface. In other words, information representing the graphical user interface is sent or transmitted to a device configured for displaying the user interface.

An example of this graphical user interface is presented in FIG. 4a. The first area 1 is for displaying the video. According to some aspects of the disclosure the first area 1 is covering a larger part of a display 50 compared to the second area 2d. The second area 2a, 2c, 2d can be in different forms. As illustrated in FIG. 4a, the second area 2c is a menu bar area on top left of the display area. As illustrated in FIG. 6, the second area 2c are a plurality of menu items.

As illustrated in FIG. 3, the method comprises detecting S3, while displaying a video, a user input in the second area 2a, 2c, 2d. As an example the displaying device senses that a user selects the “donate” button as illustrated in FIG. 4d by placing the index finger on a touch screen enabled smartphone. According to one aspect of the disclosure the detecting is input by a user touching a touch display. According to one aspect of the disclosure the detecting is input by a user selecting an object by clicking on a mouse on a computer device. Detecting can be any kind of user input such as selecting an object on a TV-screen using a remote control or, using gesture input or voice input.

The method further comprises interrupting S4 the displaying of the video in response to detecting a user input in the second area 2a, 2c, 2d. Hence, in one example the playback of the video is stopped such that the video does not continue to play. This gives the user a more relaxed experience when e.g. making a donation.

As illustrated in FIG. 3, the method further comprises retrieving S5, in response to the detecting, from at least one server 30a, 30b, payment information associated with the second area 2a, 2c, 2d. In the “donation example” this may be the amount to be paid retrieved either directly from a payment information server 30a or from a product content server 30b that is e.g. enabling plurality of donations that can be made. In another example retrieving payment information could be product information together with price information from a product content server 30b. The payment information may be predefined values or type of information defined by an application programming interface for that server. Hence, the payment information associated with the second area 2a, 2c, 2d can be updated at a server 30a, 30b and retrieved by the electronic device 10 e.g. a server generating the graphical user interface. Hence, the graphical user interface is always updated according to the information from the server 30a, 30b.

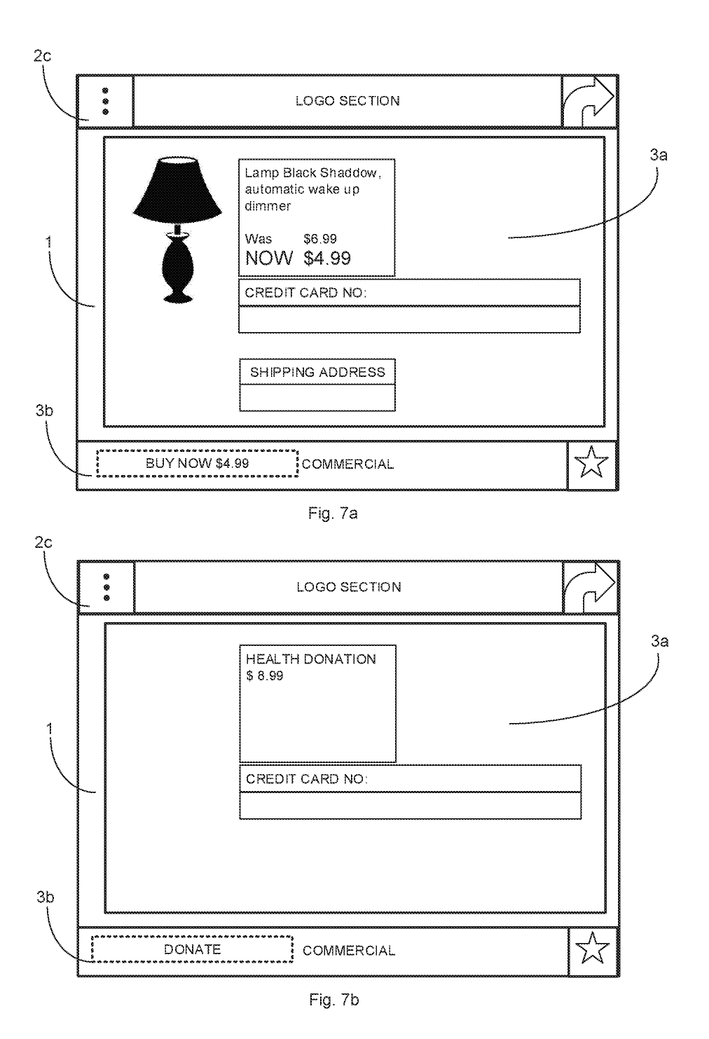

As illustrated in FIG. 3, the method further comprises generating S6, in the graphical user interface, a third area 3a, 3b configured for receiving user input for electronic payment, wherein the third area 3a, 3b is at least partly overlapping the first area 1. As illustrated in FIGS. 7a and 7b, the third area 3a is overlapping the first area 1. According to one aspect of the invention, the third area 3a is completely overlapping the first area 1. For example the graphical user interface may be created to that the user does not get distracted from content viewed in the first area 1. In particular if the video is paused, as described in step S4, there may be no need to generate a third area 3a that is smaller than the first area 1. The third area 3a and 3b are configured for receiving user input for electronic payment. As illustrated in FIGS. 7 a and 7b this may for example be input of credit card information. It could also be configured for receiving user input such as signing in to an account for payment, e.g. via Paypal or a bank. The third area is configured for receiving user input. The user input could for example be typing in alphanumerical information such as credit card information using a physical keyboard on a computer or a soft keyboard provided on a touch screen.

As illustrated in FIG. 4a, the third area 3b is a commercial bar area on bottom of the display area. According to some aspects of the invention the area 2c is displayed as long as the video is playing. The third area 3b can have different looks and e.g. present alternatives to the user dependent on how the graphical user interface is generated. According to some aspects of the invention, the third area 3b changes dependent on time. According to some aspects of the invention, the third area 3b changes dependent on the content provided in the second area 2a, 2c, 2d.

The method further comprises displaying S7, in the third area 3, the retrieved payment information. According to some aspects of the invention, the third area 3 is generated with payment information retrieved from at least one server 30a, 30b. In the FIG. 7a, the payment information is a picture of a product, a lamp, an information text to the product, and the price information of the product. As illustrated in FIG. 7b, the payment information is the amount to be paid for a donation.

The method further comprises receiving S8 user input associated with the electronic payment being provided in the third area 3. The user e.g. types in the credit card number in the required fields for example using a physical keyboard or a soft keyboard on a touch display of a smartphone for user input or any other type of user input such as speech to text etc.

As illustrated in FIG. 3, the method further comprises performing S9 the electronic payment based on the retrieved information and user input received in the third area 3 via a payment server 30a. The payment is performed generating a transaction and or an order. Typically a third party payment service provider is enabling the payment such as Paypal or a bank but the electronic payment can also be performed via a payment server that is maintained by the service provider of the server 10. According to some aspects of the disclosure, the connection between the electronic device 10, e.g. a server 10, and the payment server 30a is defined by an application programming interface 104a.

The method further comprises resuming S10 the displaying of the video in response to completing the electronic payment. Hence, the user can, after performing the payment, smoothly continue to watch the video from where it was paused and continue to stay in the video player or interface providing the playback of the video.

Further aspects of the disclosure will now be described, some aspects illustrated with the accompanying Figures.

According to some aspects of the disclosure, the payment information comprises price information data stored in at least one server 30a, 30b. The price can be either a product price from e.g. a product content server 30b or a price for a donation that can either be from a product content server 30b or directly from a payment information server 30a as illustrated in FIG. 2. Hence the price information presented in the generated graphical user interface will always be up to date according to the information stored and maintained by e.g. a certain web shop providing the data in a server 30a, 30b.

According to some aspects of the disclosure, the third area 3 that is configured for receiving user input for electronic payment, is generated using an application programming interface 104a, 104b, 104c defining the graphical user interface of the third area 3. Hence, the data used for generating the graphical user interface is controlled and can be managed to create a well-functioning graphical user interface with a positive user experience. When generating the graphical user interface it may be beneficial to create a common graphical user interface so that the user feel comfortable when returning and making electronic payment while viewing a video in the graphical user interface generated by the method of this disclosure. According to some aspects of the disclosure, the server 30a, 30b has an application programming interface that is used by the device 10 to generate the graphical user interface of the third area 3. According to some aspects of the disclosure at least part of the information from the server 30a, 30b goes via an application programming interface of the device 10 as illustrated in FIG. 1.

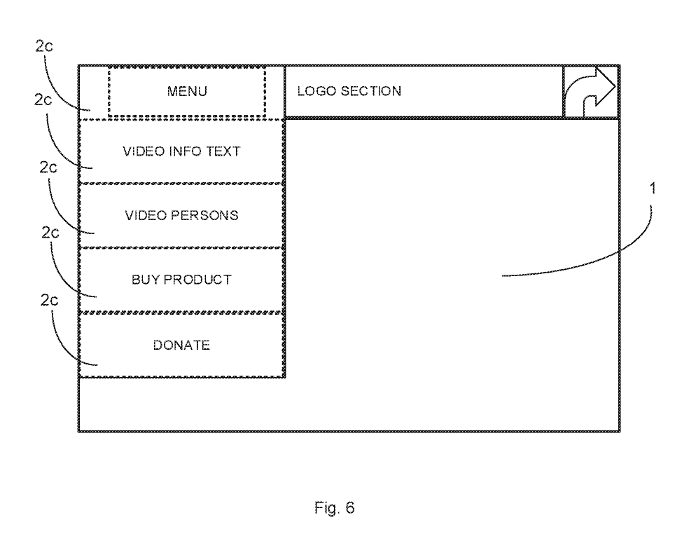

According to some aspects of the disclosure, the second area 2a is generated on the first area 1 at a specific position providing user interaction during a specific time period while displaying the video. According to some aspects of the disclosure the graphical user interface is generated according to instructions by a user given in a software program that is used for generating the graphical user interface. A user programming such graphical user interface can take the content of the video in consideration when deciding when and where to generate the second area 2a. This allows an intuitive way of e.g. providing an advertisement that is related to an object that is visualized in a scene of the video and hence easy accessible for the user that is viewing the video. In FIG. 5a, the second area 2a is illustrated by the square with the text “BUY NOW $4.99”. In one example a video is playing and when, as in FIG. 5a, the lamp is showing the “BUY NOW $4.99” 2a square can be visible as long as the lamp is visible in the scene. The second area 2a can hence be defined at a specific position at a specific time meaning it can also appear to move around during a certain time, e.g. so that it is always placed on or next to the object in the video that it refers to. This will give an intuitive way for the viewer to get the attention to a certain object that e.g. can be purchased. In one example the video is a movie and while the movie is played, different offers are presented at different times while the movie is playing. Hence the method can be performed numerous times while viewing the same video. In one example the user can go back in the video to e.g. find the offers over and over again.

According to some aspects of the disclosure, the second area is generated below the first area 1 at a specific position providing user interaction while displaying the video. This makes it possible to always enable electronic payment for the user at any time while watching the video.

According to some aspects of the disclosure, the second area is generated below the first area at a specific position providing user interaction when the video is paused. This makes it possible to enable electronic payment for the user at a time chosen by the user.

According to some aspects of the disclosure, the method is performed in a server 10 adapted to generate a graphical user interface for a web browser or an application displaying the graphical user interface on a display 50. Hence, the server 10 will process and generate a graphical user interface configured to be presented on different types of electronic devices. E.g. different mobile devices may run different operation systems and the server must adapt the content so that it can generate a graphical user interface adapted to be displayed on a device that is running a certain software and/or operating system.

According to some aspects of the disclosure, the method is performed in a server adapted to generate a graphical user interface and provided via a web server to a web browser or an application displaying the graphical user interface on a display. Hence, the graphical user interface is provided via a web server. The web server can process and generate the graphical user interface configured to be presented on a web browser or an application displaying the graphical user interface on a display.

According to some aspects of the disclosure, a computer program stored in a memory that is adapted to perform the steps of the method is provided. According to some aspects of the disclosure, a computer program is stored in a memory 101 of the device 10 and processed by a processing circuitry 103 adapted to perform the steps of the method.

According to some aspects, the disclosure proposes an electronic device 10 configured for generating a graphical user interface. The electronic device comprises a memory 101 and a communication interface 102 for providing communication with at least one server 20, 30a, 30b, 40. The electronic device 10 further comprises a processing circuitry 103 that is configured to cause the electronic device 10 to generate a graphical user interface comprising a first area 1 for displaying a video and a second area 2a, 2c, 2d for providing user interaction on or next to the first area 1. The processing circuitry 103 is further configured to cause the electronic device to display the graphical user interface and to detect, while displaying a video, a user input in the second area 2a, 2c, 2d. The processing circuitry 103 is further configured to cause the electronic device 10 to retrieve, in response to the detecting, from at least one server 30a, 30b, payment information associated with the second area 2a, 2c, 2d, to generate in the graphical user interface, a third area 3 configured for receiving user input for electronic payment, wherein the third area 3 is at least partly overlapping the first area 1, and to display, in the third area 3, the retrieved payment information. The processing circuitry 103 is further configured to cause the electronic device to receive user input associated with the electronic payment being provided in the third area 3 and to perform the electronic payment based on the retrieved information and user input received in the third area 3 via a payment server 30a.

The electronic device 10 is configured to perform any of the aspects of the methods described above.

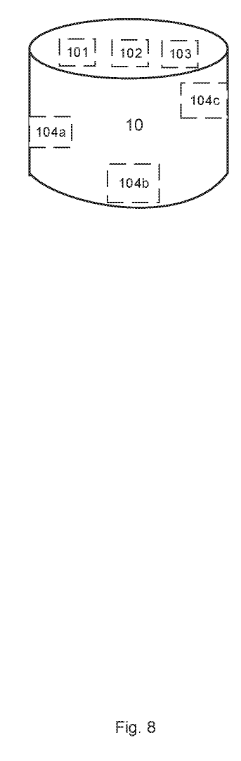

In FIG. 8 an electronic device 10 according to some aspects of the disclosure is illustrated. The electronic device 10 comprises a memory 101, a communication interface 102, a processing circuitry 103 and an application programming interface 104a, 104b, 104c. The electronic device can e.g. be a graphical user interface server 10 is adapted to be connected to other electronic devices via the Internet 15. The electronic device 10 contains a software program code that is stored in the memory 101. The software program code is processed in the processing circuitry 103 and utilizes the communication interface 102 and the application programming interface 104a, 104b, 104c and the connection to other electronic devices via the Internet 15 in order to perform any of the aspects of the method described above.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, at an electronic device comprising:
generating a graphical user interface comprising a first area for displaying a video and a second area for providing user interaction on or next to the first area,
displaying the graphical user interface,
detecting, while displaying a video, a user input in the second area,
retrieving, in response to the detecting, from at least one server, payment information associated with the second area,
generating, in the graphical user interface, a third area configured for receiving user input for electronic payment, wherein the third area is at least partly overlapping the first area,
displaying, in the third area, the retrieved payment information,
receiving user input associated with the electronic payment being provided in the third area, and
performing the electronic payment based on the retrieved information and user input received in the third area via a payment server.

2. The method according to claim 1, further comprising:
interrupting the displaying of the video in response to detecting a user input in the second area.

3. The method according to claim 2, further comprising:
resuming the displaying of the video in response to completing the electronic payment.

4. The method according to claim 1, wherein the payment information comprising price information data stored in at least one server.

5. The method according to claim 1, wherein:
the third area configured for receiving user input for electronic payment, is generated using an application programming interface defining the graphical user interface of the third area.

6. The method according to claim 1, wherein:
the second area is generated on the first area at a specific position providing user interaction during a specific time period while displaying the video.

7. The method according to claim 1, wherein:
the second area is generated below the first area at a specific position providing user interaction while displaying the video.

8. The method according to claim 1, wherein the method is performed in a server adapted to generate a graphical user interface for a web browser or an application displaying the graphical user interface on a display.

9. The method according to claim 1, wherein the method is performed in a server adapted to generate a graphical user interface and provided via a web server to a web browser or an application displaying the graphical user interface on a display.

10. An electronic device configured for generating a graphical user interface, the electronic device comprising:
a memory;
a communication interface for providing communication with at least one server; and
a processing circuitry, configured to cause the electronic device to:
generate a graphical user interface comprising a first area for displaying a video and a second area for providing user interaction on or next to the first area,
display the graphical user interface,
detect, while displaying a video, a user input in the second area,
retrieve, in response to the detecting, from at least one server, payment information associated with the second area,
generate in the graphical user interface, a third area configured for receiving user input for electronic payment, wherein the third area is at least partly overlapping the first area,
display, in the third area, the retrieved payment information,
receive user input associated with the electronic payment being provided in the third area, and
perform the electronic payment based on the retrieved information and user input received in the third area via a payment server.
